(19) United States
(12) Patent Application Publication
(10) Pub. No.: US 2023/0089560 A1
(43) Pub. Date: Mar. 23, 2023

(54) METHOD AND DEVICE FOR MAPPING THE THICKNESS OF AN OBJECT

(71) Applicants: CENTRE NATIONAL DE LA RECHERCHE SCIENTIFIQUE, Paris (FR); UNIVERSITE GRENOBLE ALPES, Saint Martin d'Heres (FR)

(72) Inventors: Aurélien GOURRIER, St Etienne de Crossey (FR); Philippe MOREAU, Meylan (FR)

(21) Appl. No.: 17/759,421

(22) PCT Filed: Feb. 12, 2021
(86) PCT No.: PCT/EP2021/053553

§ 371 Date: Jul. 25, 2022

(30) Foreign Application Priority Data
Feb. 14, 2020 (FR) 2001474

(51) Int. Cl. G01B 11/06

(52) U.S. Cl. CPC G01B 11/06

(57) ABSTRACT

A method for producing a thickness map of an object, the method being implemented via at least one pair of measurement pathways; the method including measuring, by means of optical sensors, the light reflected and/or scattered by two opposing surfaces of a reference object in order to obtain reference signals of the positions of the two reference surfaces, and of the object to be measured in order to obtain measurement signals of the positions of the two surfaces of the object, at a plurality of measuring points, determining thickness values for the measuring points on the basis of the measurement signals and a reference thickness, and producing a thickness map of the object on the basis of the thickness values.

### TECHNICAL FIELD

The present invention relates to a method for establishing a thickness map of an object, in particular of a chemically and physically heterogeneous object. It also relates to a contactless measuring device implementing such a method.

The field of the invention is, non-limitatively, that of contactless metrological measurements and topologic imaging.

### STATE OF THE ART

Various types of measurements of the thickness of objects are known, and they may be classified in two categories: measurements with and without contact.

The mechanical techniques of thickness measurement by contact are based mainly on the application of pressure on either side of the object to be measured, placed between two rigid surfaces of a measuring device (for example between a reference surface and a spherical tip or between two flat arms). An average measurement of the thickness of the zone of the object in contact with the two surfaces of the device is then obtained by measuring the relative displacement of these contact surfaces after calibration (for example defining thickness as zero when the two measuring surfaces of the instrument are in direct contact). In general, one of the two contact surfaces is fixed and the measurement is determined by the displacement of the second. Devices such as the calliper gauge, micrometer or surface plate combined with a sensor are in this category.

The accuracy of thickness measurements by contact depends, to a first approximation, on the calibration and the quality of measurement of the displacement of one or both contact surfaces of the device. This accuracy depends, however, on the hardness of the object and the pressure exerted by the measuring device. In the case of a large contact force and/or a small contact surface, the pressure applied on the object may induce plastic deformations, which distort the measurement and damage the object. This applies in particular to soft objects (for example polymers or malleable metals), and fragile samples (for example thin layers on a substrate, ceramics or porous objects).

Contactless thickness measurements make it possible to solve these problems of damage to the object. There is a wide variety of methods whose common feature is measurement of the interaction between a probe and the object. The main devices used are based on acoustic, optical, X-ray or terahertz measurements. The nature of the probe and the associated detection technologies essentially determine the measurement accuracy. When great accuracy is required for the thickness, for example of the order of a micrometre, optical solutions are often advantageous.

However, these contactless techniques of thickness measurement have their limitations, depending on the nature of the object. Thus, optical interferometry is mainly reserved for measurements of homogeneous, transparent objects (for example plastic films) as it is not very suitable for heterogeneous objects with variations of refractive index. Objects of a heterogeneous nature may therefore prove more complicated to measure, depending on the nature of the probe used.

When the thickness of the object is not uniform, it is necessary to measure the object at different positions. The number of measurements to be carried out depends on the assumptions about the geometry of the object. In order to obtain an adequate statistical accuracy, it is necessary to reconstruct a thickness map of the sample. This may in particular allow variations in object thickness to be detected that were not suspected initially or, conversely, when it is assumed that there are large local variations in thickness.

The existing technologies for contactless measurement do not allow mapping having both a high degree of accuracy with regard to the thickness (of the order of at least 1 μm) and a high lateral accuracy (<10 μm) for objects consisting of heterogeneous materials.

The aim of the present invention is to provide a method and a device for mapping the thickness of an object that make it possible to overcome at least one of these drawbacks.

### DISCLOSURE OF THE INVENTION

One aim of the present invention is to propose a method and a device allowing contactless mapping of the thickness of an object, which may be heterogeneous.

Another aim of the present invention is to propose a method and a device making it possible to achieve sub-micrometric accuracy for thickness and accuracy for the map of the order of 10 μm or less.

At least one of these aims is achieved with a method for establishing a thickness map of an object, the method being implemented by a contactless measuring device comprising:
at least one pair of measurement paths, each measurement path comprising a light source configured to produce a measuring light beam and an optical sensor configured to produce distance measurements,
a receiving zone of an object to be measured, the receiving zone comprising an object plane and/or axis,
   in which two measurement paths are arranged on either side of the object plane and/or axis so as to be able to measure the object from two opposite sides, and so that the planes of the measurement paths, each comprising the light source, the optical sensor and the light beam, are non-parallel; said method comprising the following steps:
measurement, by the optical sensors, of the light reflected and/or diffused by the zones illuminated by the light beams of two opposite surfaces of a reference object of known thickness e_{REF}, to obtain a first and a second reference signal of the positions of the two reference surfaces,
measurement, by the optical sensors, of the light reflected and/or diffused by the zones illuminated by the light beams of two opposite surfaces of the object to be measured, to obtain a first and a second measuring signal of the positions of the two surfaces of the object, at a plurality of measuring points on the object,
determination, from the first and second measuring signal and from the reference thickness, e_{REF}, of a plurality of thickness values, e, for the plurality of measuring points, and
establishment of a thickness map of the object from the plurality of thickness values of the object to be measured,

the measurements (16) of a surface of the object (4) being desynchronized from the measurements (16) of the other surface of the object (4).

The method according to the invention constitutes a method of contactless optical mapping of the thickness of an object. The method according to the invention makes it possible to perform topological imaging on the two surfaces of the object. The method is based on detection of the specular or diffuse reflection of a light spot on each of the opposite surfaces of the object to determine the position of these surfaces, at several measuring points.

The establishment of a thickness map is then based on repetition of the thickness measurement, allowing the zone of interest of the object to be covered. This may be carried out by displacing the object relatively to the optical probes, or vice versa. The accuracy obtained for the thickness is therefore independent of the displacement of the probe or of the object and depends solely on the thickness measurement system, comprising the measurement paths. Regarding the accuracy of mapping, it depends both on the dimension of the measurement system (for example the size of the light spot on the surface of the object) and the spacing of the measuring points on the object. The spacing is determined by the technique for scanning the object according to the measuring points. Establishment of a thickness map is in this case similar to a form of imaging by scanning, often called micro-imaging.

The present invention makes it possible to combine the intrinsic accuracy of the optical resolutions while being free from the problems of variations of optical indices within the object, which greatly limit the use of optical interferometry.

The object may in particular extend in two dimensions, i.e. be of small thickness relative to the other two dimensions. The object may therefore be of the film, lamina, section, or plate type, having two opposite surfaces, and the thickness of which must be determined over a part of or its entire lateral and longitudinal extension. The thickness of the object to be measured is determined by differential measurement of the position of each of the two surfaces of the object.

The object may also be an object of cylindrical or spherical symmetry, such as rods, cables or wires. In this case, the terms “two opposite sides” or “two opposite surfaces” are meant in the sense that the measurement paths, being arranged on either side of the object, make it possible to measure the object from these two sides, even if it is a single cylindrical surface, for example.

In the method according to the present invention, the measurements from one side of the object are shifted in time with respect to the measurements from the other side of the object. The combination of this desynchronization of the measurements with the arrangement of the measurement paths in non-parallel planes makes it possible to properly identify and therefore distinguish the light spots coming from one or other side of the object. Detection errors can be avoided and the accuracy of the measurements can thus be increased.

Indeed, by avoiding the measuring beam of one measurement path being detected by another measurement path, signal interferences between the two measurement paths are avoided.

The method according to the invention makes it possible to map the thickness of any type of object. Advantageously, the object may be heterogeneous in chemical composition and/or physical properties. The object may in particular comprise transparent and opaque zones or elastic and hard or brittle zones, and having spatial variations of the refractive index, absorption, etc. The method according to the invention makes it possible in particular to map the thickness of objects made from composite, multiphase or biological materials, and objects that are very thin and/or partially transparent.

In the case when the object has height variations on part of one or other of the surfaces, thickness mapping is similar to topographic imaging. Such an object may be of the circuit board type for which a visualization of the geometry of the components can be mapped on either side of the board by the method according to the invention.

The object may also have an axis of symmetry and may display variations of thickness or of height along this axis or along its diameter, such as a screw, a tube, a core sample drilled in an object, or a surgical implant.

The measuring beams are adapted so as to be able to perform, with their respective optical sensors, measurements of distance, or of position, on an object. This means that the diameter or the lateral extension of a measuring beam is small compared to the size or dimension of the object to be measured.

According to an embodiment, one or more pairs of additional measurement paths may be utilized in the method according to the invention. These additional pairs make it possible to carry out complementary measurements with respect to the first pair, so as to be able to reduce the measurement time for an object or increase the measurement accuracy.

Advantageously, the method according to the invention may further comprise a step of correlating the thickness measurements with the positions of the corresponding measuring points of the two sides of the object.

This step makes it possible to guarantee that two corresponding measurements on either side of the object are used for determining a thickness value.

According to one example, the correlation step may be carried out by calibrating the position of one of the optical sensors with respect to the position of the other optical sensor by means of a reference resolution object.

According to another example, the correlation step may be carried out by correlating the measurements of the first side of the object to be measured with the measurements of the second side of the object for at least some of the plurality of measuring points.

According to an embodiment, the method may further comprise an interpolation step of the thickness values determined for at least some of the plurality of measuring points. Thus, the thickness map is defined even at the places of the object where the thickness has not been measured.

According to another aspect of the invention, a device is proposed for establishing a thickness map of an object, comprising:
at least one pair of measurement paths, each measurement path comprising a light source configured to produce a measuring light beam and an optical sensor configured to produce distance measurements;
a receiving zone of an object to be measured, the receiving zone comprising an object plane and/or axis, in which the two measurement paths are arranged on either side of the object plane and/or object axis so as to be able to measure the object from two opposite sides and so that the planes of the measurement paths, each comprising the light source, the optical sensor and the light beam, are non-parallel;
means of displacement configured for displacing the object, in the object plane and/or along the object axis, in relation to the measurement paths, or means of displacement configured for displacing the measurement paths, on either side of the object plane and/or object axis, in relation to the object; and
a processing module configured for processing the distance measurements;
   arranged for carrying out all the steps of the method according to the invention.

Advantageously, each measurement path may comprise a light source producing an almost parallel or focused measuring beam.

This light source is preferably a laser source.

According to an advantageous embodiment, each optical sensor may comprise one or more optical refocusing elements of the pinhole or lens type and a position sensor.

The position sensor may be, for example, a sensor of the CMOS or CCD type.

The method and the device according to the invention may be implemented in particular for metrological measurement for mapping the thickness of biological samples, such as histology slides, for development of biomaterials or for quality control in the field of materials.

### DESCRIPTION OF THE FIGURES AND EMBODIMENTS

Other advantages and characteristics will become apparent on examination of the detailed description of non-limitative examples, and the attached diagrams, in which:

FIG. 1 is a diagrammatic representation of a non-limitative embodiment example of a device according to the present invention;

FIG. 2 is a diagrammatic representation of a non-limitative embodiment example of a method according to the present invention;

FIGS. 3a to 3d illustrate steps of the method according to embodiments of the invention; and

FIG. 4 illustrates yet another step of the method according to embodiments of the invention.

It is well understood that the embodiments that will be described hereinafter are in no way limitative. Variants of the invention can in particular be imagined comprising only a selection of the characteristics described hereinafter, in isolation from the other characteristics described, if this selection of characteristics is sufficient to confer a technical advantage or to differentiate the invention with respect to the state of the prior art. This selection comprises at least one, preferably functional, characteristic without structural details, or with only a part of the structural details if this part alone is sufficient to confer a technical advantage or to differentiate the invention with respect to the state of the prior art.

In particular, all the variants and all the embodiments described can be combined together if there is no objection to this combination from a technical point of view.

In the figures, elements common to several figures retain the same reference.

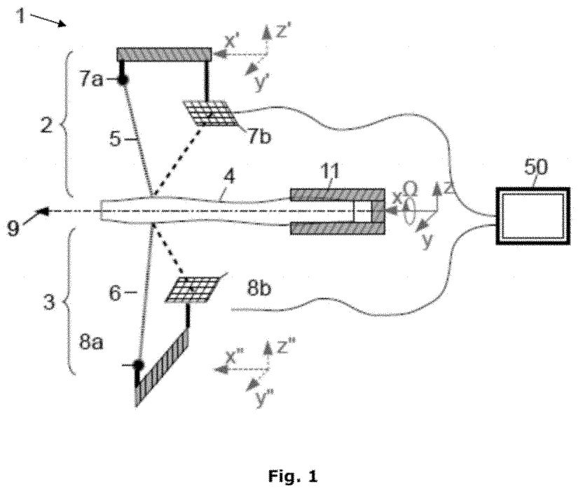

FIG. 1 is a diagrammatic representation of a non-limitative embodiment example of a device according to the present invention.

The device according to the present invention is arranged for measuring the thickness of an object and establishing a map of the thickness of the object.

The object 4 may be an object extending along one or two axes. FIG. 1 shows a section of an object 4 extending along an object axis 9 (corresponding to the x axis here). It may in particular be a histology slide or a film of composite materials or of biomaterials. More generally, the object may be a fragile, elastic and/or heterogeneous sample.

The device 1 comprises two measurement paths 2, 3. Each measurement path 2, 3 comprises a light source 7a, 8a, emitting a measuring light beam 5, 6, which can be collimated or focused, and an optical distance sensor 7b, 8b.

The light source 7a, 8a may be a laser, the beam from which is shaped by one or more lenses and/or collimators (not shown).

In the embodiment shown, the optical sensors 7b, 8b allow detection of the position of a reflected or diffused light beam. These sensors may be, for example, diodes based on CMOS (Complementary Metal Oxide Semiconductor) technology. To focus the reflected or diffused beam on the detector and thus detect the position of the light spot on the surface of the sample, a system of lenses or of pinholes (not shown) is arranged in front of the sensor 7b, 8b.

A receiving zone is arranged between the two measurement paths 2, 3 of the device 1. The receiving zone makes it possible to accommodate the object to be measured 4. It is formed, for example, by a support 11 for fixing the object. The receiving zone is arranged so that when the object 4 is present therein, a specular or diffuse reflection of a measuring beam can be produced and detected on each of the two opposite sides of the object 4. A light spot then appears on each of the optical sensors at a certain position thereof.

Preferably, the light source 7a, 8a and the optical sensor 7b, 8b are located in one and the same module or sensor head 7, 8. These sensor heads 7, 8 are simply arranged head to tail so as to be able to place an object to be measured 4 between these heads 7, 8 so that they are positioned on either side of the object to be measured 4.

Of course, the light sources 7a, 8a and the optical sensors 7b, 8b may also constitute independent modules.

In the embodiment shown in FIG. 1, the sensor heads 7, 8 are arranged non-parallel. The measurement path or sensor head planes, formed respectively by the light source 7a, 8a, the optical sensor 7b, 8b and the measuring beam 5, 6, are perpendicular to one another. One of the measurement heads is arranged in the x′-z′ plane and the other in the y″-z″ plane.

However, other configurations that are not symmetrical relative to an object plane 9 and with non-parallel planes of the measurement heads or paths can of course be envisaged for the device 1.

The device 1 comprises displacing means allowing the object 4 to be displaced along the x axis and/or the y axis relative to the measurement paths. A rotation Ω about the x axis may also be envisaged for approximately cylindrical objects. This makes it possible to displace the light spots produced by the measuring beams 5, 6 on the two sides of the object, and thus perform measurements of thickness at different places of the object. The object support 11 may form part of the displacing means.

Alternatively, the displacing means may be arranged for displacing the two sensors in the x′-y′-z′ and x″-y″-z″ frames of reference, the object 4 being fixed.

The device 1 according to the invention also comprises a processing module 50. The processing module 50 makes it possible to determine, from the measurements made by the optical sensors 7, 8, thickness values at different places of the object 4, in order to produce a thickness map of the object 4. This processing module 50 may comprise a microcontroller, a central processing unit or calculation unit, a microprocessor, and/or suitable software means.

The device according to the invention is configured to implement all the steps of a method according to the invention for establishing a thickness map of an object.

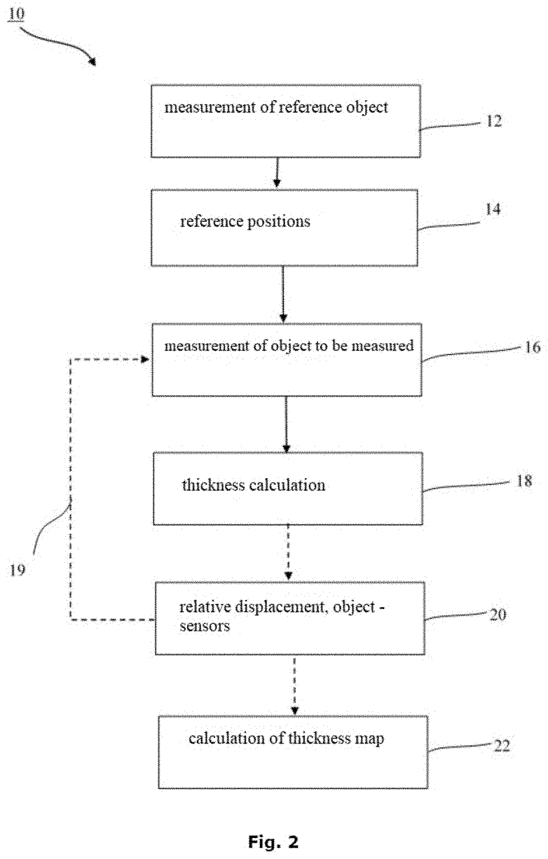

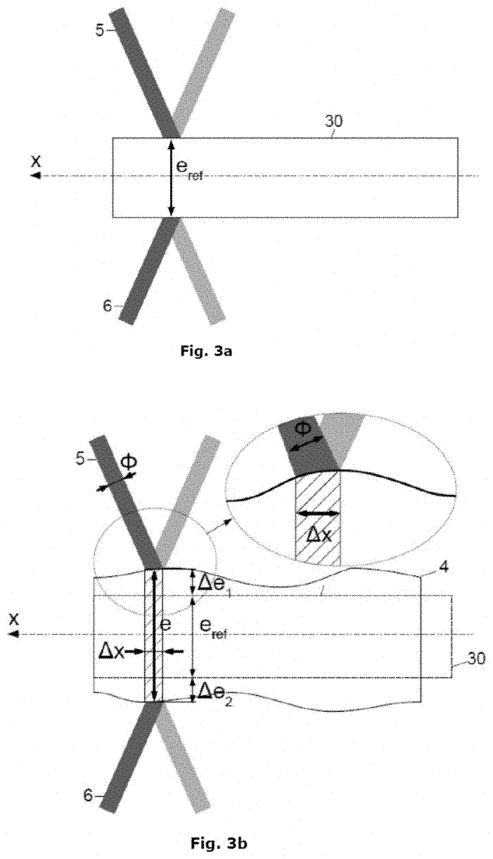

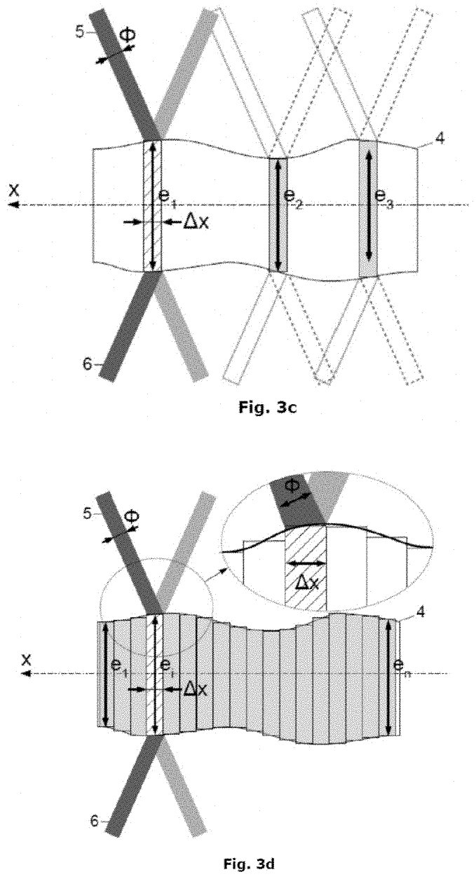

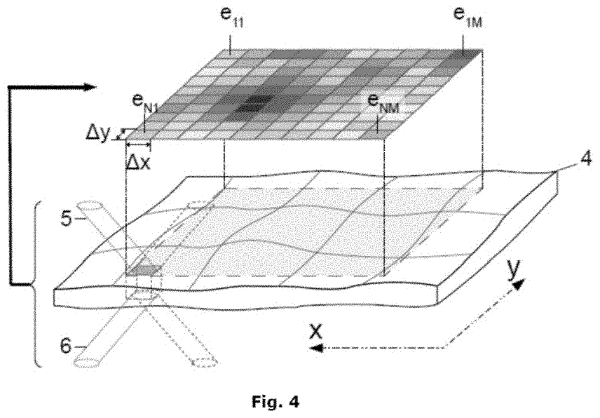

The device 1 according to the embodiment shown in FIG. 1 may in particular be used to implement the steps of the method for establishing a thickness map according to the invention that will be described hereinafter. The method according to embodiments of the invention will be described with reference to FIGS. 2, 3a, 3b, 3c, 3d and 4. In FIGS. 3a to 3d and 4, the measuring beams and the reflected and/or diffused beams are illustrated in the x-z plane only for greater legibility. However, the planes of the measurement heads or paths of the device 1 are always in non-parallel planes.

FIG. 2 is a diagrammatic representation of a non-limitative embodiment example of a measurement method according to the invention.

The method 10 comprises a step 12 of measurement, by the optical sensors, of the reflected and/or diffused light from a reference object.

The reference object 30, illustrated in FIG. 3a, may be, for example, a gauge block consisting of a plate having two opposite parallel surfaces of certified thickness. The gauge block may be made from plastic, ceramic, silicon, etc.

On each of the two opposite sides of the reference object 30, the reflected and/or diffused light is measured at a measuring point. The optical sensors 7b, 8b thus detect a first and a second reference signal, respectively.

The reference signal corresponds to a light spot detected at a determined position of each surface of the reference object 30 and therefore at a determined position on the optical sensor 7b, 8b. As the thickness e_{REF} of the reference object 30 and the positions of the light sources 7a, 8a and optical sensors 7b, 8b are known, it is then possible to calibrate the positions of the optical sensors 7b, 8b with respect to this reference thickness e_{REF}.

In a step 16 of the method 10 shown in FIG. 2, the reference object 30 is replaced by an object 4 to be measured. This step 16 of measurement of the object 4 is shown in FIG. 3b.

The light reflected and/or diffused from each side of the object to be measured 4 is detected by the optical sensors 7b, 8b as well as the position of the light spots on the detectors 7b, 8b. The positions of the light spots are determined with respect to the positions of the light spots for the reference object 30. A first and a second measuring signal, respectively, are thus obtained.

Depending on the nature of the object to be measured (opacity, homogeneity, etc.), it is possible that the optical sensors capture not only the light reflected and/or diffused from the external surfaces of the object, but also the light reflected and/or diffused from the interior of the object, for example by interfaces separating different zones in the object (transparent/opaque, zones having different densities or made from different materials). One possibility for discriminating these different light spots and only selecting that coming from the external surface is for only the most intense spot to be taken into account by the sensor. Other discrimination techniques may of course be used.

In a step 18 of the method 10, a thickness value e of the object to be measured 4 is determined from the variation Δe₁ of the first measuring signal and the variation Δe₂ of the second measuring signal with respect to the reference thickness e_{REF} as follows:

e=e_{REF}Δe₁+Δe₂

This step 18 is also illustrated in FIG. 3b.

In order to be able to perform the determination step 18 accurately, it is necessary to guarantee that each sensor detects the light spot located on the side of the object facing it and therefore the light coming from the corresponding source.

For this purpose, a spatial (or angular) separation of the measurements is performed, avoiding directing the measuring beam from one of the sensor heads towards the sensor of the other sensor head. For this purpose, the sensor heads are located in non-parallel planes, as explained above with reference to FIG. 1. Thus, the measuring beams are not parallel.

Temporal separation of the measurements is also performed. The measurements on one side of the object are thus shifted in time, or desynchronized, with respect to the measurements on the other side of the object. Preferably, for each measuring point, measurement is carried out first on one side of the object and then on the other side. Other types of desynchronization are of course possible.

The steps of measuring 16 on the object and of calculation 18 of the thickness e are carried out for a plurality of measuring points on the object 4, to obtain a plurality of thickness values (e₁, e₂, e₃, etc.). For this, in a displacement step 20 of the method, the object 4 is displaced with respect to the measuring beams 5, 6, along the x and/or y axis, and as often as necessary. The displacement along the x axis is illustrated in FIG. 3c. The measuring 16 and calculating 18 steps may then be repeated as often as desired.

The displacement may be effected by displacing either the object 4, or all of the sources and sensors, along the x axis and/or y axis. The choice of the manner of displacement depends in particular on the nature and the dimensions of the object.

In the case of a cylindrical object, the object is preferably placed with its axis along the x axis. Relative displacement is achieved by coupling a translation along the axis of the object and a rotation about this axis. The use of two measurement paths makes it possible to limit the rotation to 180 degrees.

Of course, in order to be able to determine the thickness of the object 4 for the plurality of measuring points, the latter must be distributed identically on both measured faces of the object.

The steps of measuring 16, of calculation 18 of the thickness and of displacement 20 may be ordered in different ways.

According to a first example, as shown in FIG. 2, repetition 19 of the steps of measuring 16, calculation 18 and displacement 20 is carried out so as to perform these steps 16, 18, 20 one after another for each measuring point of a plurality of measuring points. This embodiment of the method 10 makes it possible in particular to obtain an image of the thickness of the object in real time, during measurement.

According to a second example, the step 16 of measuring the object is first carried out for each of the measuring points, by relatively displacing the object with respect to the measurement paths before each new measurement. A cloud of measured points is obtained for each side of the object. Then all the measurements are used for calculating the thickness of the object for all the measuring points, thus obtaining a thickness map of the object.

From the plurality of thickness values, a thickness map of the object is established in a step 22 of the method 10, by correlating the plurality of thickness values with the relative displacement of the object. The thickness map corresponds to an image of the measured object 4 representing the thickness at all the measured points.

The accuracy obtained with regard to the thickness depends on the accuracy of the measurement and of that defined for the gauge block. The lateral resolution of the map depends on a combination of factors including the dimension ø of the measuring beams 5, 6, which defines a lateral resolution Δx on the sample, and the difference between the various measuring points. A greater accuracy will be obtained for mapping if the object 4 is displaced more finely in the beam, as illustrated in FIG. 3d. The thickness map thus represents an approximation of the space between the two real surfaces of the object 4 between the two measuring beams 5, 6.

This principle is illustrated in FIG. 4. A flat object 4 extending in two dimensions and irregular in thickness is mapped by the two measurement paths, represented by the measuring beams 5, 6 as dotted lines. The thickness eᵢⱼ of an elementary volume of the object 4 is therefore measured following a grid of displacements of distances Δx and Δy in the object plane, where i and j correspond to the matrix indices of the mapping grid (1<i<M, 1<j<N). Here, the distances Δx and Δy represent, to a first approximation, the projection of the diameter of the light spot of the beam 5, 6 at the surface of the object 4. Owing to the symmetry of the arrangement, these values Δx and Δy are approximately identical on either side of the object. The zone of the object 4 scanned is indicated with a dotted line on the upper surface of the object 4. A thickness value eᵢⱼ is calculated for each elementary volume. An image of the thickness of the object corresponding to the pattern of the grid may thus be obtained comprising the set of measuring points eᵢⱼ.

According to the embodiments, step 22 of calculation of the thickness map of the method 10 according to the invention may also comprise an interpolation step. During this step, the thickness values obtained from the plurality of pairs of measured points are used for determining other thickness values by interpolation of the measured values.

It is then possible to utilize different patterns of measuring points, and in particular irregular patterns, and obtain a complete thickness map owing to the interpolation step. The interpolation step also makes it possible to establish the thickness map despite measurements that cannot be used and have to be discarded.

So as to be able to attribute, to each measured point on one side of the object, a corresponding measured point on the other side, the method 10 may further comprise a correlation step for correlating the two clouds of measured points.

According to an embodiment of the method 10, the correlation step 6 is performed by calibrating the positions of the two optical sensors. To this end, a resolution object having a well-known geometry may be used as reference object. This resolution object may be constituted, for example, by an engraving of well-determined dimensions on either side of a gauge block. The engraving may also be a through hole. In all cases, the geometry of the resolution object must be known to an accuracy at least equivalent to the lateral dimensions of the measuring beams 5, 6. The measurements of the two sides of the resolution object by the two sensors, respectively, are used for referencing the positions of the two sensors with respect to one another.

According to another embodiment, the correlation step is performed by correlating the measurements of the first side of the object to be measured with the measurements of the second side of the object for at least two/some of the plurality of measuring points. Correlation according to this embodiment corresponds to correlation of images. The measured points for each side of the object to be measured form a cloud of points for each side. The two clouds may be compared for identifying specific common features, such as for example the edges of the object or any other geometric reference of known position on either side of the object. Thus, it is possible to associate a measured point of an edge for one side of the object with a corresponding measured point for the other side of the object. This then makes it possible to associate all the other corresponding measured points. Determination of the different thickness values may then be carried out with the appropriate pairs of points.

Of course, the invention is not limited to the examples which have just been described and numerous adjustments can be made to these examples without exceeding the scope of the invention.

1. A method for establishing a thickness map of an object, the method being implemented by a contactless measuring device comprising:
at least one pair of measurement paths, each measurement path comprising a light source configured to produce a measuring light beam and an optical sensor configured to produce distance measurements;
a receiving zone of an object to be measured, the receiving zone comprising an object plane and/or axis;
in which two measurement paths are arranged on either side of the object plane and/or object axis so as to be able to measure the object on two opposite sides, and so that the planes of the measurement paths, each comprising the light source, the optical sensor and the light beam, are non-parallel; the method comprises the following steps:
measurement, by the optical sensors, of the light reflected and/or diffused by the zones illuminated by the light beams of two opposite surfaces of a reference object of known thickness e_{REF}, to obtain a first and a second reference signal of the positions of the two reference surfaces;
measurement, by the optical sensors, of the light reflected and/or diffused by the zones illuminated by the light beams of two opposite surfaces of the object to be measured, to obtain a first and a second measuring signal of the positions of the two surfaces of the object, at a plurality of measuring points on the object;
determination, from the first and second measuring signal and from the reference thickness e_{REF}, of a plurality of thickness values, e, for the plurality of measuring points; and
establishment of a thickness map of the object from the plurality of thickness values of the object to be measured,
the measurements of one surface of the object being desynchronized from the measurements of the other surface of the object.

2. The method according to claim 1, characterized in that it further comprises a step of correlating the thickness measurements with the positions of the corresponding measuring points of the two sides of the object.

3. The method according to claim 2, characterized in that the correlation step is performed by calibrating the position of one of the optical sensors with respect to the position of the other optical sensor by means of a reference resolution object.

4. The method according to claim 1, characterized in that the steps of determination of thickness values of the object and of establishment of the thickness map are carried out in real time.

5. The method according to claim 2, characterized in that the correlation step is performed by correlating the measurements of the first side of the object to be measured with the measurements of the second side of the object for at least some of the plurality of measuring points.

6. The method according to claim 1, characterized in that it further comprises an interpolation step of the thickness values determined for at least some of the plurality of measuring points.

7. A device for establishing a thickness map of an object, comprising:
at least one pair of measurement paths, each measurement path comprising a light source configured to produce a measuring light beam; and an optical sensor configured to produce distance measurements;
a receiving zone of an object to be measured, the receiving zone comprising an object plane and/or axis, in which the two measurement paths are arranged on either side of the object plane and/or object axis so as to be able to measure the object from two opposite sides and so that the planes of the measurement paths, each comprising the light source, the optical sensor and the light beam, are non-parallel;
displacing means configured for displacing the object, in the object plane and/or along the object axis, in relation to the measurement paths, or displacing means configured for displacing the measurement paths, on either side of the object plane and/or object axis, in relation to the object; and
a processing module configured for processing the distance measurements;
arranged for implementing all the steps of the method according to claim 1.

8. The device according to claim 7, characterized in that each measurement path comprises a light source, preferably a laser, producing an almost parallel or focused measuring beam.

9. The device according to claim 7, characterized in that each optical sensor comprises one or more refocusing optical elements of the pinhole or lens type and a position sensor.
